(19) United States
(12) Patent Application Publication
(10) Pub. No.: US 2013/0086748 A1
(43) Pub. Date: Apr. 11, 2013

(54) COMPACT LIGHTWEIGHT COLLAPSIBLE STRETCHER WITH REINFORCED BED

(71) Applicants: Joanne S. Walter, Blue Ridge, GA (US); Michael Duncan, Simpsonville, SC (US); Tommy Sweatman, Simpsonville, SC (US); Matthew S. Westra, Simpsonville, SC (US)

(72) Inventors: Joanne S. Walter, Blue Ridge, GA (US); Michael Duncan, Simpsonville, SC (US); Tommy Sweatman, Simpsonville, SC (US); Matthew S. Westra, Simpsonville, SC (US)

(21) Appl. No.: 13/490,111

(22) Filed: Jun. 6, 2012

Related U.S. Application Data
(60) Provisional application No. 61/493,698, filed on Jun. 6, 2011.

(51) Int. Cl. A61G 1/013

(52) U.S. Cl. CPC A61G 1/013
USPC 5/627

(57) ABSTRACT

A carbon fiber frame assembly having a first collapsible frame pole and a second collapsible frame pole interconnected by a bed member. The bed member is reinforced with nylon strips for receiving and supporting a person between the frame poles. The first frame pole and the second frame pole consisting of a plurality of interlocking pole segments moveable between a collapsed configuration wherein the pole segments for each of the frame poles are generally disengaged from each other, and an erected configuration wherein the pole segments are aligned and connected end to end to form each of the frame poles. An elastic retention cord is disposed within a hollow interior of the first and second frame poles to bundle the frame segments together when in the disassembled configuration and to resist separation in the erected configuration. The distal end of each frame pole includes an extendable locking handle assembly.

### BACKGROUND OF THE INVENTION

1. Field of the Invention

The present invention relates to litters, stretchers, and the like for transporting injured persons, and more particularly, to a compact lightweight collapsible composite stretcher having a reinforced bed that can be carried in a backpack and can be quickly assembled for use and disassembled for storage. The stretcher is further capable of being decontaminated from chemical and biological warfare agents, as well as other hazardous materials.

2. Description of Related Art

The prior art is replete with various types of litters/stretchers for patient evacuation. While some stretchers are capable of fold to some extent, they generally do not collapse into a package suitable for carrying in the field, such as in a backpack. Only recently have a very few stretcher designs provided a compact folding design sufficient to be carried in a backpack manner. However, none of these stretchers were designed to be ultra lightweight and with a streamlined design to facilitate ease of assembly and disassembly while maintaining sufficient structural rigidity to carry an injured person properly. Further, no stretchers of a lightweight compact design provide resistance to the types of chemical and biological warfare agents that may be encountered today sufficient to be decontaminated when exposed to such severely hazardous material.

Although some litters on the market claim to be lightweight, the benchmark standard for lightweight litters has been the Talon® 90C to North American Rescue, LLC, which weights about 7.4 kg. The present invention seeks to significantly reduce this weight to provide an ultra lightweight stretcher.

Many of the litters in use today are difficult to open as the hinges require precise alignment to enable opening and connecting. Also, many current hinge designs have been known to fail under stress. Also, most popular litter designs use spreader bars that require a high foot force to expand the spreader bar to hold the litters open, components which add weight and increase the complexity of use.

Aside from problems in the use of current litter designs, there are numerous issues in manufacturing. For example, most aluminium litters are manufactured using a heat treatment, which is difficult to achieve correctly and may lead to cracking in weld HAZ. Further, welded aluminium structure is expensive to fabricate and difficult to affect repairs, particularly in service. Also, some litter designs on the market utilize a fabricated detent assembly used to lock extendable handles, which may be prone to failure under excessive weight and prolonged use.

The present invention seeks to not only significantly reduce the weight and compactness of a stretcher for transport, but to improve the overall durability, ease of assembly and use, and decontamination ability, while simplifying and reducing overall manufacturing costs.

Accordingly, it is an object of the present invention to provide a compact foldable stretcher to facilitate transport and storage of the stretcher when not in use.

It is an object of the present invention to provide a stretcher of lighter weight than current stretcher designs, such that the present invention weights less than previous “light weight” designs.

It is an object of the present invention to provide a stretcher that is easy to assembly and does not require the use of a spreader bar.

It is an object of the present invention to provide a stretcher having extendable handles with a reliable locking arrangement to secure the handles in place during use.

It is an object of the present invention to provide a stretcher that can be repaired using interchangeable parts.

It is an object of the present invention to provide a stretcher capable of resisting severely hazardous materials such as chemical and biological warfare agents sufficient to allow for onsite decontamination of the stretcher while carrying a person so that the stretcher may continue to be used without further contamination to the users.

### SUMMARY OF THE INVENTION

The above objectives are accomplished according to the present invention by providing a collapsible lightweight stretcher for transporting injured persons, comprising a frame assembly having a first collapsible frame pole and a second collapsible frame pole; the first collapsible frame pole and the second collapsible frame pole consisting of a plurality of interlocking pole segments that are releasable connectable for moving between a collapsed configuration wherein the pole segments are generally disengaged from each other, and an erected configuration wherein the pole segments are aligned and connected end to end to form each of the first and second collapsible frame poles; an elastic retention cord disposed within a hollow interior of the first and second frame poles resisting separation of the pole segments when in the erected configuration, and maintaining the pole segments together as a bundle when in the collapsed configuration; an extendable handle assembly slidably carried generally at a distal end of each the first and second collapsible frame poles, the handle assembly being operable between a retracted position in which a hand grip portion of the handle assembly is generally contained within the frame poles, and an extended position in which the hand grip is exposed for carrying the frame poles; a bed member carried by the first and second collapsible frame poles adapted for receiving and supporting the weight of a person between the frame poles; a series of support strips extending across the width of a top side of the bed member and being laterally spaced along the length of the bed member for reinforcing the bed member; and, at least one x-brace disposed on a bottom side of the bed member defined by intersecting cross-straps arranged in an x-configuration for reinforcing the bed member.

In a further advantageous embodiment, each of the pole segments is constructed of a carbon fiber epoxy composite.

In a further advantageous embodiment, the bed member comprises a flexible fabric material selected from the group consisting of monofilament polypropylene, polyester, polyamide, nylon, and blends thereof.

In a further advantageous embodiment, the support strips are arranged generally perpendicular to the first and second collapsible frame poles.

In a further advantageous embodiment, the support strips comprise generally one inch wide nylon tape having a tensile strength of at least about 4200 lbs.

In a further advantageous embodiment, the cross-straps comprise generally two inch wide nylon tape having a tensile strength of at least about 4200 lbs.

In a further advantageous embodiment, a first x-brace is disposed on a first half of the bottom side of the bed member, and a second x-brace is disposed on a second half of the bottom side of the bed member.

In a further advantageous embodiment, the bed member includes a plurality of pole receiving loops disposed generally along opposing first and second perimeter sides of the bed member for receiving the first and second collapsible frame poles, respectively.

In a further advantageous embodiment, each of the pole receiving loops is defined by a material flap extending from the perimeter side that is folded back onto and secured to the bed member.

In a further advantageous embodiment, a plurality of attachment members secure the pole receiving loops to the first and second collapsible frame poles to resist shifting of the bed member on the first and second collapsible frame poles when transporting a person.

In a further advantageous embodiment, the attachment members releasably secure the bed member to the first and second collapsible frame poles.

In a further advantageous embodiment, a plurality of tie-down straps are carried by the bed member for securing a person to the bed member.

In a further advantageous embodiment, at least one drainage port is disposed in the bed member.

In a further advantageous embodiment, the pole segments include at least one of a male and female connector portion for interconnecting with adjacent pole segments, wherein the male connector portion is defined by a reduced diameter end portion of a pole segment, and the female connector portion is defined by the hollow interior of the pole segments at a distal end portion of a given pole segment, wherein the male connector portion is received in a releasable friction fit arrangement with an adjacent female connector portion for interconnecting the pole segments.

In a further advantageous embodiment, the extendable handle assembly includes a control arm carrying the hand grip portion, the control arm operatively associated with the frame poles for controlling extraction and retraction of the hand grip portion.

In a further advantageous embodiment, the control arm includes a control slot extending along a portion of the length of the control arm, the control slot receiving a retaining pin fixedly carried by the frame pole, wherein the control arm extends and retracts by moving the control slot along the retaining pin and is prevented from separating from the frame pole when an end of the control slot engages the retaining pin.

In a further advantageous embodiment, the control arm includes a spring biased key member being received into a keyway disposed in the frame poles, wherein the key member engages the keyway when the handle assembly is moved to the extended position to prevent separation of the handle assembly from the respective frame pole.

In a further advantageous embodiment, the spring biased key member includes a slanted engaging surface that cooperates with an edge of the keyway to directed the key member downward when the handle assembly is moved to the retracted position from the extended position.

### BRIEF DESCRIPTION OF THE DRAWINGS

The construction designed to carry out the invention will hereinafter be described, together with other features thereof. The invention will be more readily understood from a reading of the following specification and by reference to the accompanying drawings forming a part thereof, wherein an example of the invention is shown and wherein:

FIG. 1 shows a top view of the stretcher according to the present invention;

FIG. 2 shows a top view of a portion of the stretcher according to the present invention;

FIG. 3 shows a top view of the interconnection of the bed member to the frame pole according to the present invention;

FIG. 4 shows a top view of a distal end of a frame pole with a handle in an extended position according to the present invention;

FIG. 5 shows a top view of a distal end of a frame pole with the handle in a retracted position according to the present invention;

FIG. 6 shows a bottom view of a distal end of a frame pole having a keyway and the handle in a retracted position according to the present invention;

FIG. 7 shows a bottom view of a distal end of a frame pole having a key projecting into the keyway and the handle in the extend position according to the present invention;

FIG. 8 shows a close-up bottom view of the key projecting into the keyway of the frame pole according to the present invention;

FIG. 9 shows a close-up of a handle with micro-ridges according to the present invention;

FIG. 10 shows a top view of a distal end of a frame pole carrying a securing member for engaging the bed member according to the present invention;

FIG. 11 show guide members extending into a distal end of a frame pole for cooperating the extendable handle according to the present invention;

FIG. 12 shows an exploded view of the joint between two pole segments exposing the elastic retention cord according to the present invention;

FIG. 13 shows a bottom view of a portion of the bed member according to the present invention;

FIG. 14 shows a bottom view of the stretcher according to the present invention;

FIG. 15 shows a side view of a distal end of a frame pole carrying a securing member for the elastic retention cord according to the present invention;

FIG. 16 shows a perspective view of the stretcher in a collapsed storage position according to the present invention;

FIG. 17 shows a bottom view of the handle according to the present invention;

FIG. 18 shows a cross-section view of the handle carried in the pole segment in an extended position according to the present invention; and,

FIG. 19 shows a cross-section view of the handle carried in the pole segment in a retracted position according to the present invention.

It will be understood by those skilled in the art that one or more aspects of this invention can meet certain objectives, while one or more other aspects can meet certain other objectives. Each objective may not apply equally, in all its respects, to every aspect of this invention. As such, the preceding objects can be viewed in the alternative with respect to any one aspect of this invention. These and other objects and features of the invention will become more fully apparent when the following detailed description is read in conjunction with the accompanying figures and examples. However, it is to be understood that both the foregoing summary of the invention and the following detailed description are of a preferred embodiment and not restrictive of the invention or other alternate embodiments of the invention. In particular, while the invention is described herein with reference to a specific embodiment, it will be appreciated that the description is illustrative of the invention and is not constructed as limiting of the invention. Various modifications and applications may occur to those who are skilled in the art, without departing from the spirit and the scope of the invention.

### DETAILED DESCRIPTION OF A PREFERRED EMBODIMENT

With reference to the drawings, the invention will now be described in more detail. In this patent the term “hazardous materials” specifically includes chemical and biological warfare agents, radioactive or poisonous elements, human bodily fluids, and other dangerous and unsafe chemicals requiring a person to be decontaminated after expose.

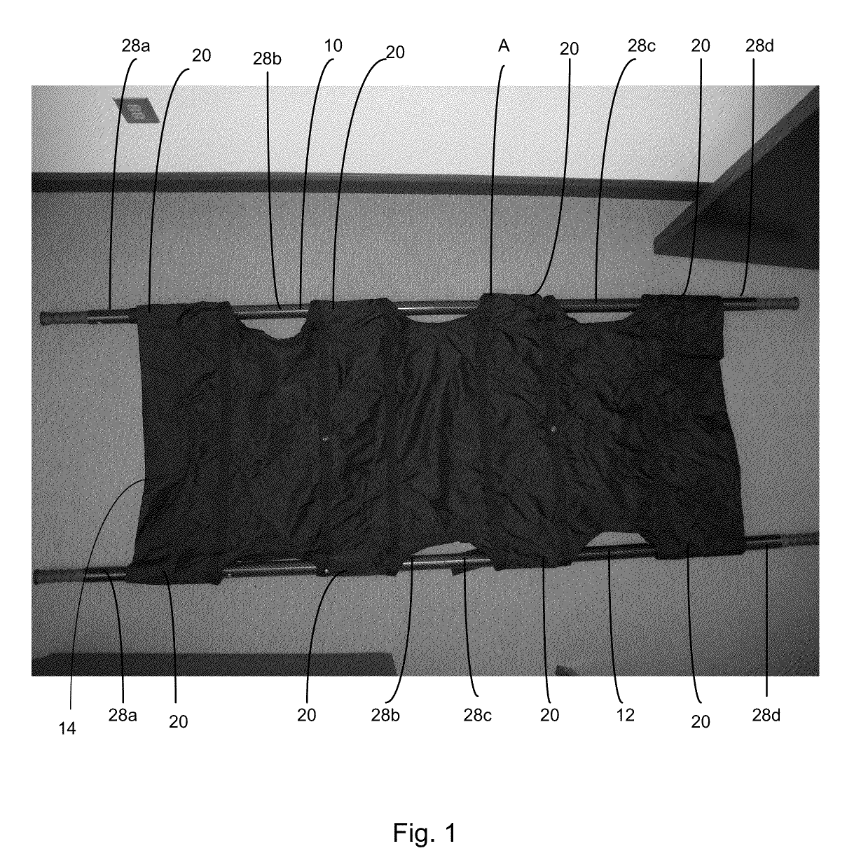

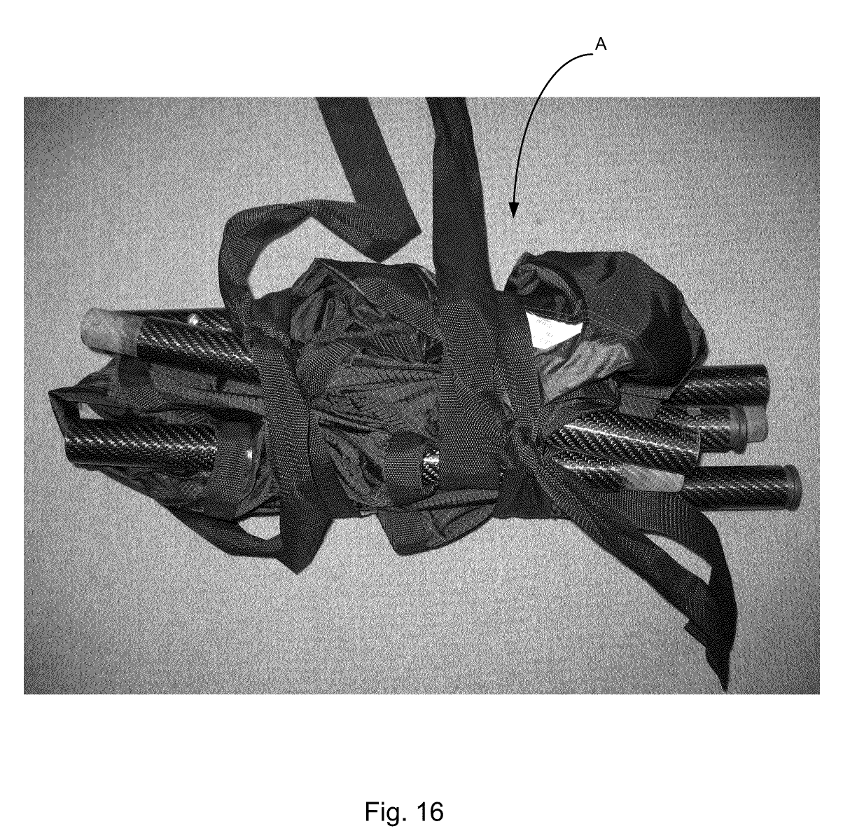

Referring to FIG. 1, a compact lightweight collapsible composite stretcher, designated generally as A, is shown having a reinforced bed comprised of a flexible fabric material for transporting injured persons and persons exposed to hazardous materials. In the illustrated embodiment, stretcher A includes a carbon fiber/epoxy composite frame assembly having a first collapsible frame pole, designated generally as 10, and a second collapsible frame pole, designated generally as 12. Frame poles 10 and 12 carry and are interconnected by reinforced bed member 14. To save on weight and space, no spreader bar is provided for laterally separating frame poles 10 and 12 during use. Rather, bed member 14 is reinforced with a series of support strips that help to reduce hammocking when carrying a person. Each of frame poles 10 and 12 may be disassembled into a series of pole segments, held together by an elastic retention cord, to configure the stretcher between an erected configuration shown in FIG. 1, and a collapsed configuration shown in FIG. 16, providing for easy storage and transportation when collapsed.

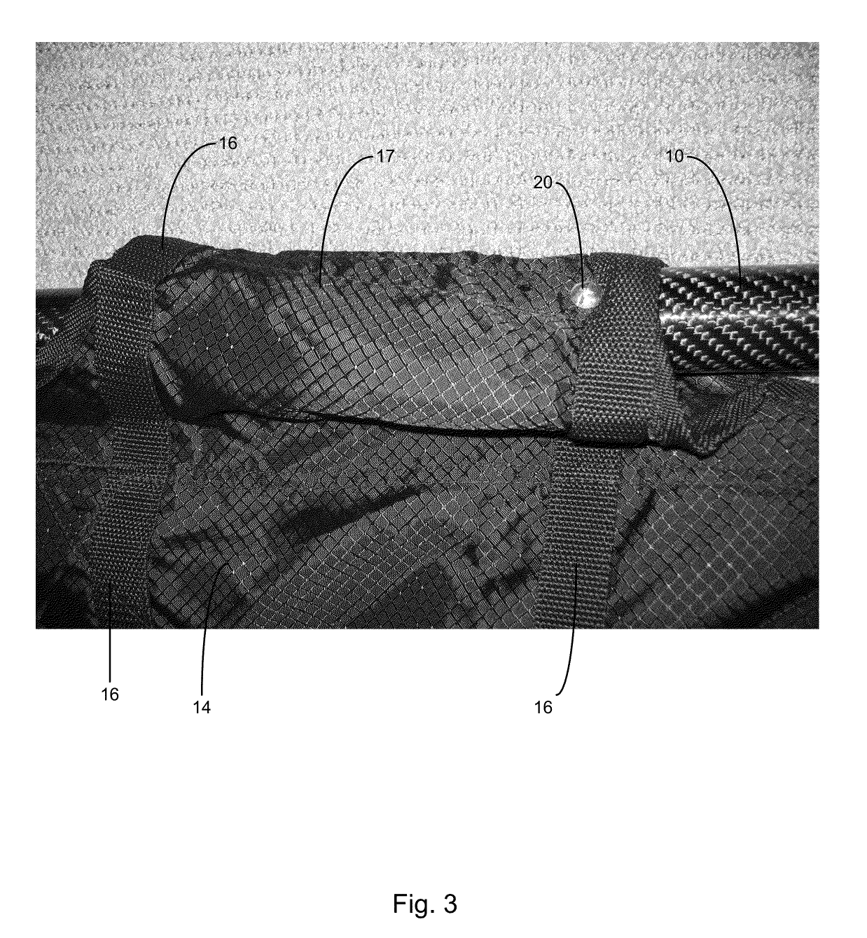

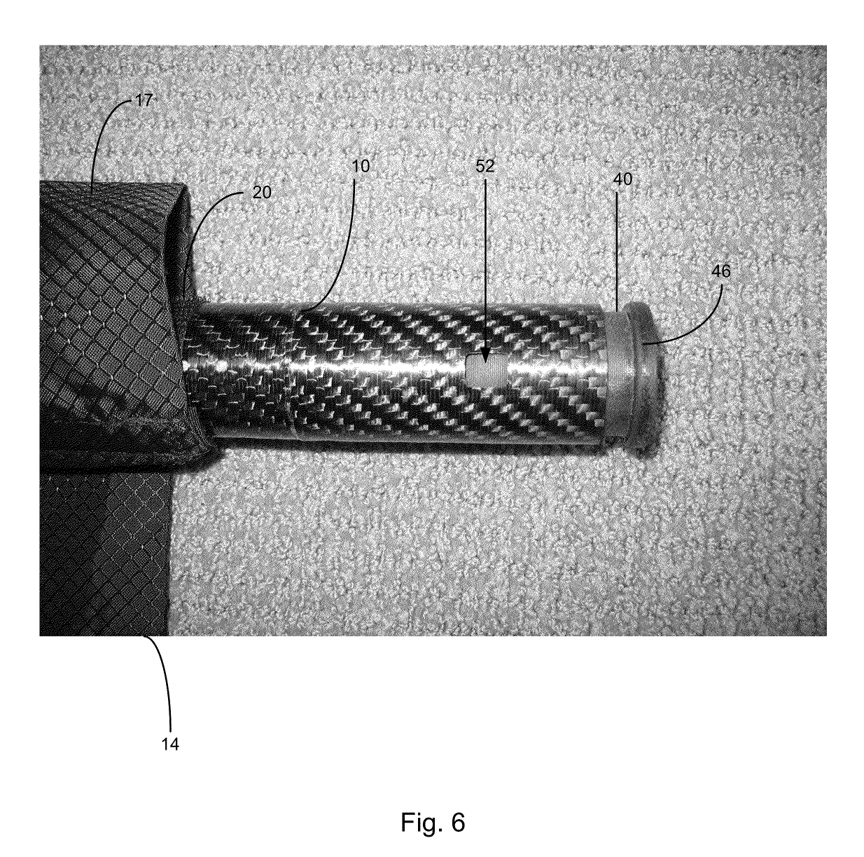

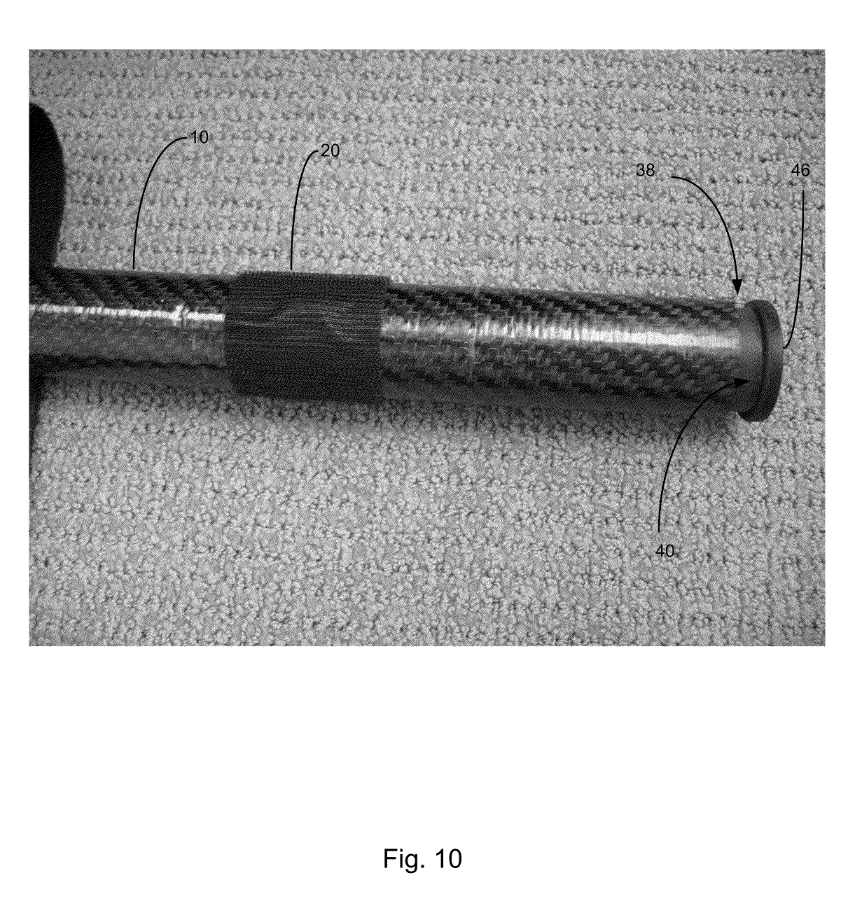

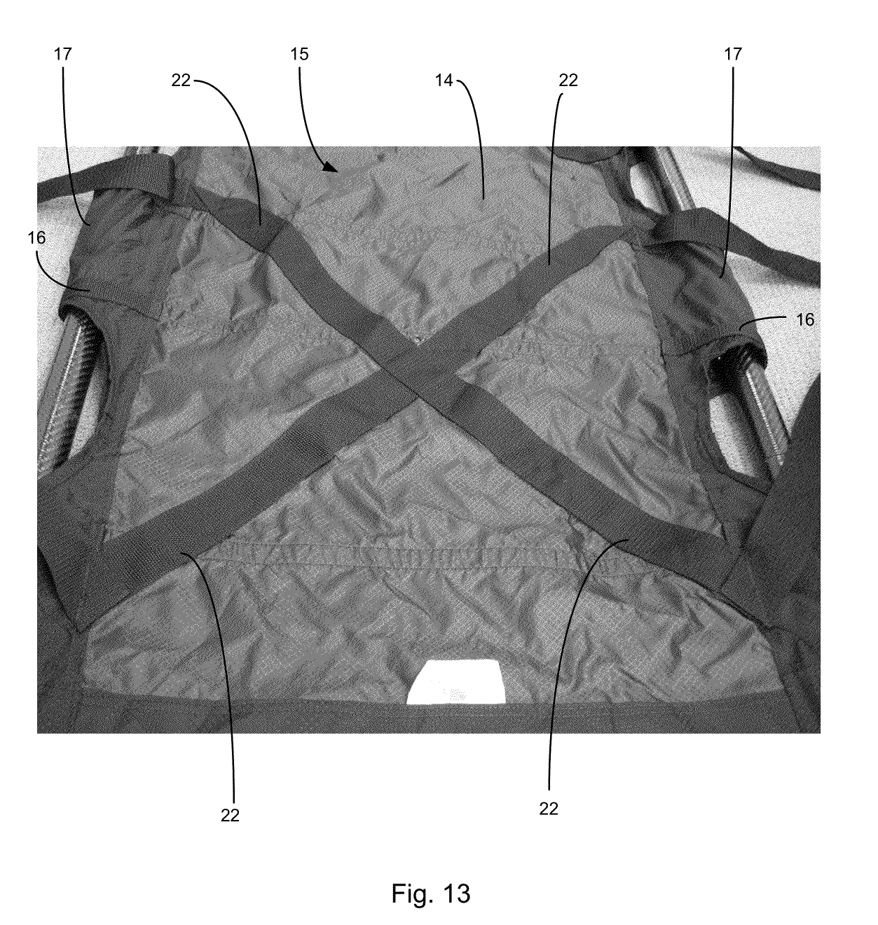

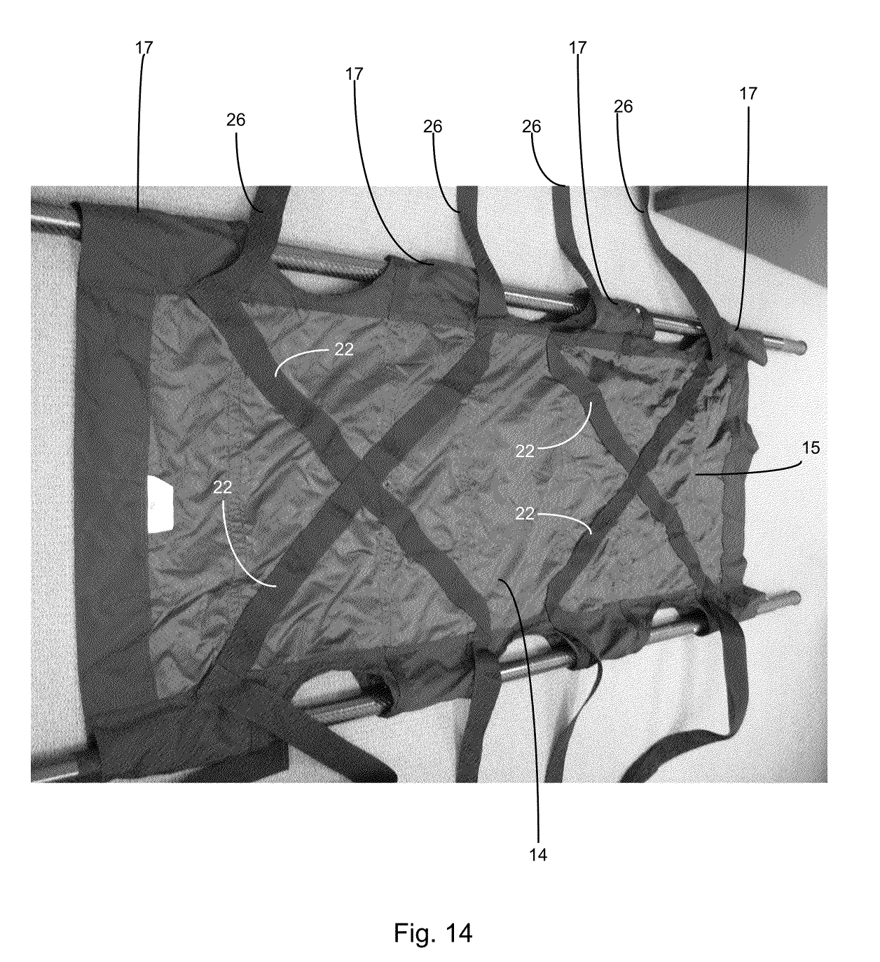

Reinforced bed member 14 is carried by the first and second frame poles for receiving and supporting a person between frame poles 10 and 12. In a preferred embodiment, bed 14 is constructed of a durable material such as monofilament polypropylene, polyester, polyamide, nylon, a blend thereof, or other suitable material which is resistant to hazardous materials and may easily and safely be decontaminated. As best shown in FIGS. 13 and 14, bed 14 includes a series of material flaps that are folded over and secured onto bottom side 15 generally along the perimeter edges of opposing sides to form a series of pole loops 17 for receiving frame poles 10 and 12. Referring to FIGS. 1 and 3, bed 14 is affixed to frame poles 10 and 12 at several location to prevent bed 14 from shift on frame poles 10 and 12 when transporting a person. In the illustrated embodiment, attachment members 20, which may be a screw, is used to attach bed 14 at pole loops 17 to frame poles 10 and 12. As shown in FIG. 1, attachment members 20 are arranged along the length of the frame poles. Alternatively or in combination, a hook and loop material such as Velcro® may be used to secure pole loops 17 of bed 14 to frame poles 10 and 12. Referring to FIG. 10, attachment members 20 may comprise a band of hook or loop material applied around frame pole 10 generally toward a distal end of the frame pole with a cooperating portion carried by loops 17 of bed 14. Referring to FIG. 6, a complementary band of hook or loop material is carried in loop 17 for securing bed 14 to attachment member 20 at the distal end of the frame pole 10.

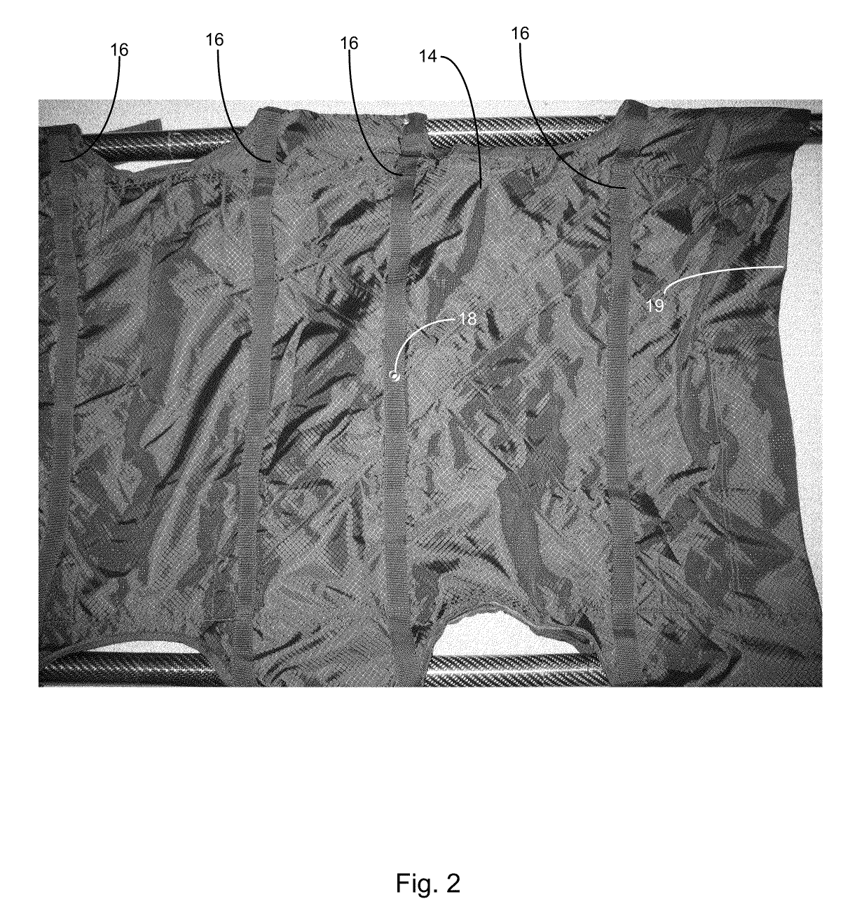

Referring to FIG. 2, a top side 19 of bed 14 is shown having a series of laterally spaced support strips 16 extending across a top side of the width of bed 14. As shown in FIG. 13, support strips 16 extend along pole loops 17 to the bottom side 15 of bed 14. Support strips 16 do not extend across bottom side 15 in the illustrated embodiment but it is noted that support strips 16 may be provided across both the top and bottom sides 19 and 15, respectively, of bed 14. Support strips 16 are laterally spaced along the entire length of bed 14 and consists of a high tensile strength foldable webbing material, such as a nylon-type tech tape, that is preferably flexible and weather resistant. Preferably, support strips 16 are constructed of 1″ nylon tech tape with a tensile strength of at least about 4200 lbs. for extreme durability and resistance to stretching to prevent failure during use and resist hammocking when carrying a person.

Referring to FIGS. 13 and 14, on bottom side 15 of bed 14 a series of intersecting cross-straps 22 are disposed to provide support for the top side 19 of the bed 14. In the illustrated embodiment, cross-straps 22 are arranged in an “X” configuration, forming two X-braces, designated generally as 24, on the bottom side 15 of bed 14. Each X-brace supports generally about half the length of bed 14, as best shown in FIG. 14. Additionally, tie-down straps 26 are carried on bottom side 15 that can be used to hold a person onto top side 19. Cross-straps 22 and tie-down straps 26 preferably consist of a high tensile strength foldable webbing material, such as a nylon-type tech tape, that is preferably flexible and weather resistant. Preferably, cross-straps 22 are constructed of 2″ nylon tech tape with a tensile strength of at least about 4200 lbs. for extreme durability and resistance to stretching to prevent failure during use and resist hammocking when carrying a person.

With further reference to FIG. 2, drainage ports 18 may be included in bed 14 at various positions to allow for drainage of fluid from the bed during use. Drainage ports 18 are preferably metal eyelets disposed generally along a middle portion of bed 14.

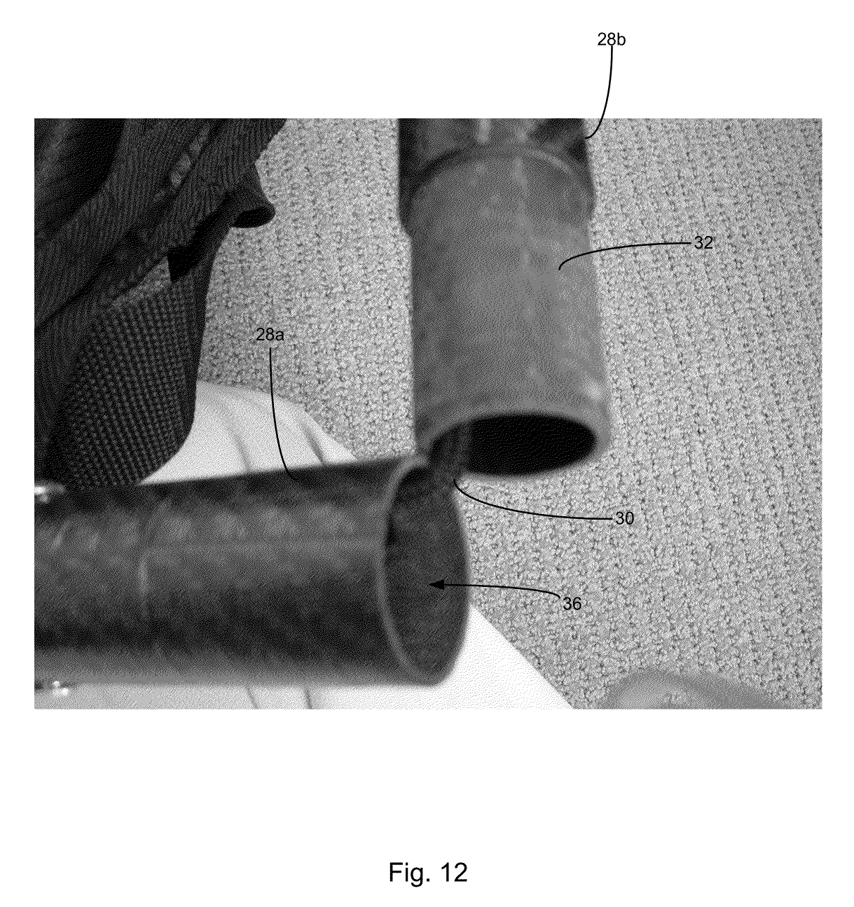

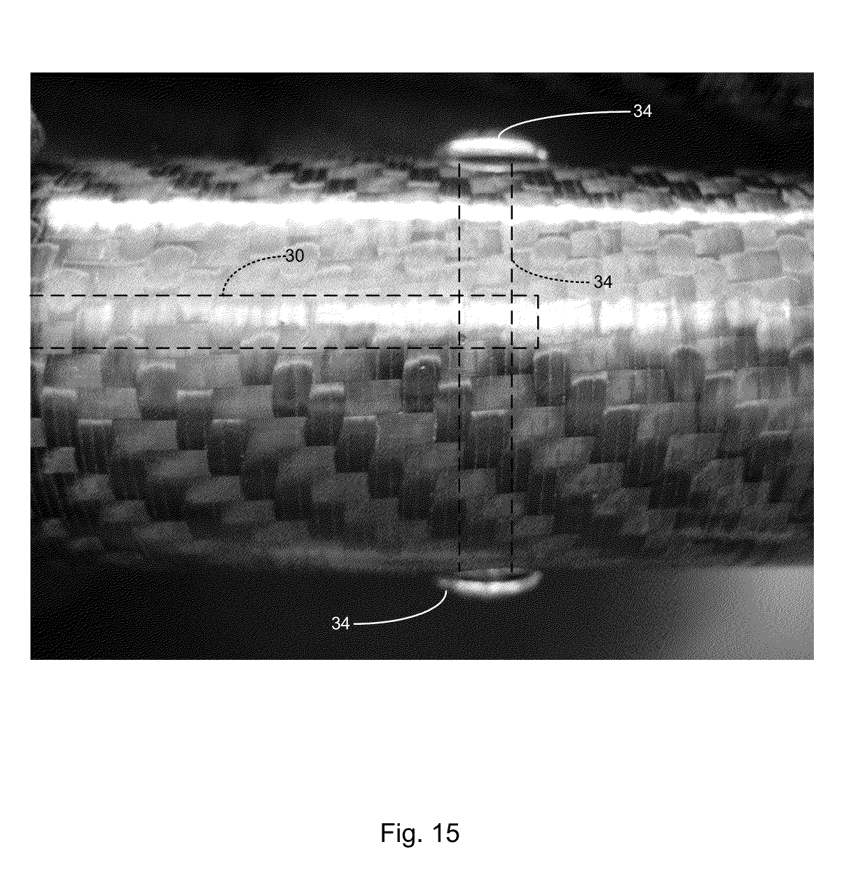

The basic design for each of collapsible frame poles 10 and 12 is a series of interlocking carbon fiber epoxy composite pole segments with releasable connections at adjacent segment ends that allow each pole segment to completely separate from adjacent pole segments to collapse for storage. Referring to FIG. 1, each of frame poles 10 and 12 include four pole segments 28a-28d. Referring to FIG. 12, the four pole segments are generally held together by an elastic retention cord 30 secured to pole segments 28a and 28d, which runs through the hollow interior of each pole segment. Referring to FIG. 15, a securing post 34 is positioned through each of pole segments 28a and 28d to which elastic retention cord 30 is secured. Accordingly, the pole segments can be disconnected from each other but remain generally held bound together by elastic retention cord 30. When assembled, elastic retention cord 30 exerts a force helping draw the pole segments together to prevent unwanted separation. Elastic retention cord 30, for example a bungee cord, ensures the structure is almost self assembling when transitioning from the collapsed condition shown in FIG. 16 to the erect condition shown in FIG. 1.

Referring to FIG. 12, the interconnection of pole segments 28a and 20b is shown. In the illustrated embodiment, the interlocking releasable connection for joining adjacent pole segments consist of a male connector end 32 being received into a female connector end 36 of the adjacent pole segment. In the illustrated arrangement, the male connector end 32 on pole segment 28b is arranged for insertion into the distal end of pole segment 28a forming female connector end 36. Male connector end 32 is formed by a reduced diameter along a portion of the distal end of the pole segment to form a friction fit arrangement with an open hollow interior portion of the adjacent pole segment which defines the female connector such that the interconnection is releasable. The remaining pole segments are likewise joined together using the appropriate male connector end 32 and female connector end 36 as required at adjacent distal ends of pole segments. The male and female connectors can be arranged in alternative patters not specifically discussed herein without departing from the teachings of the present invention.

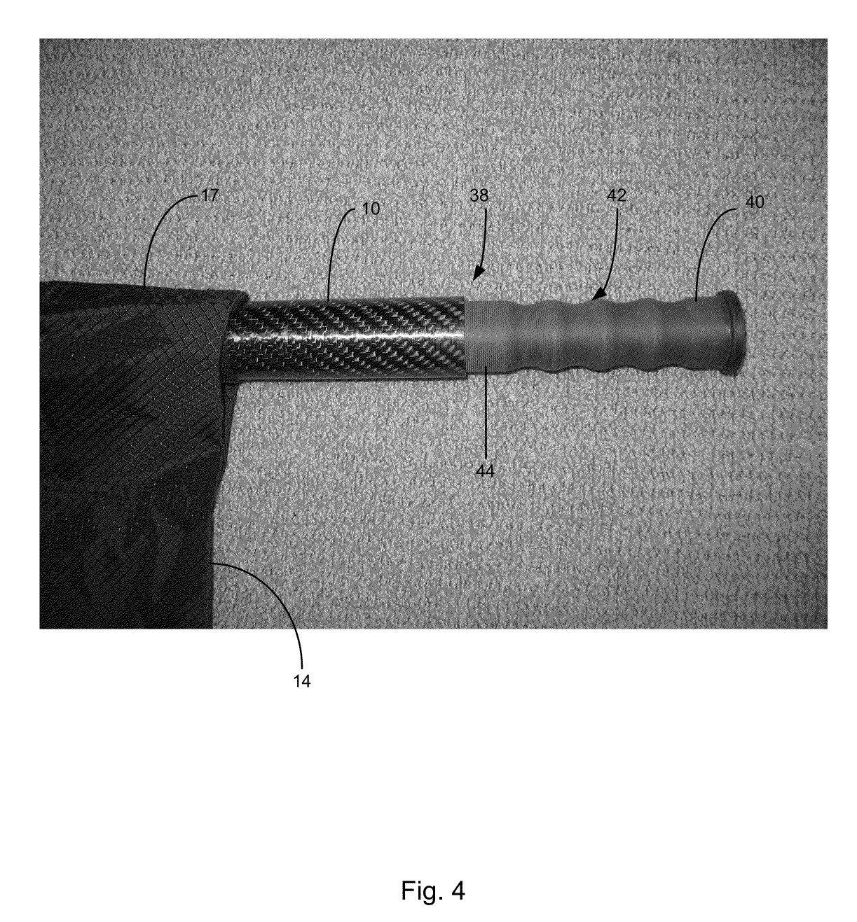

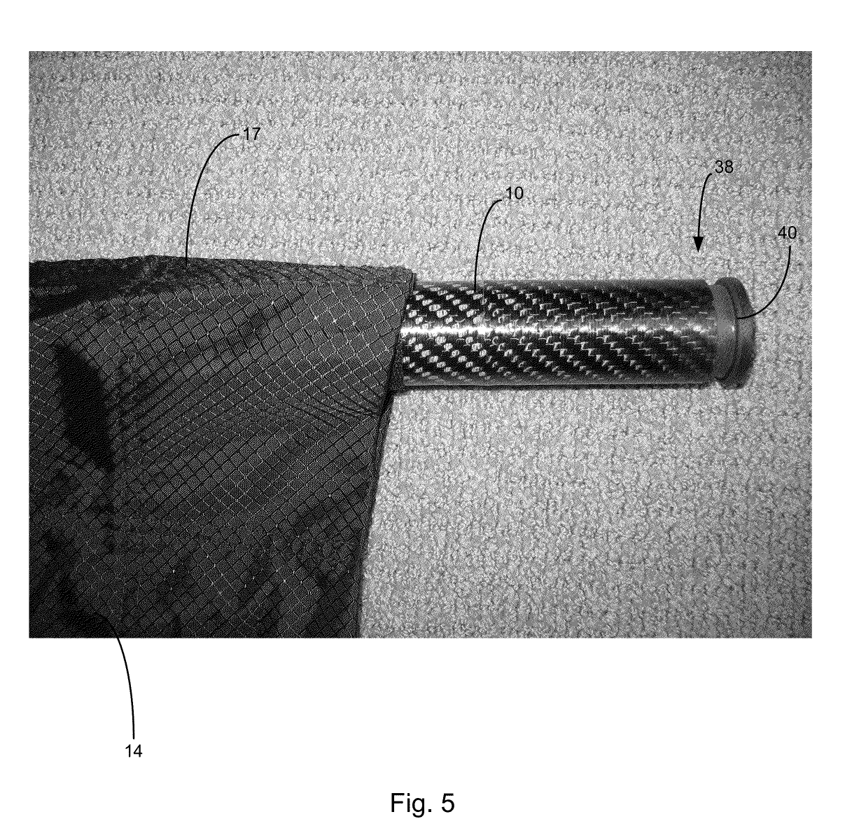

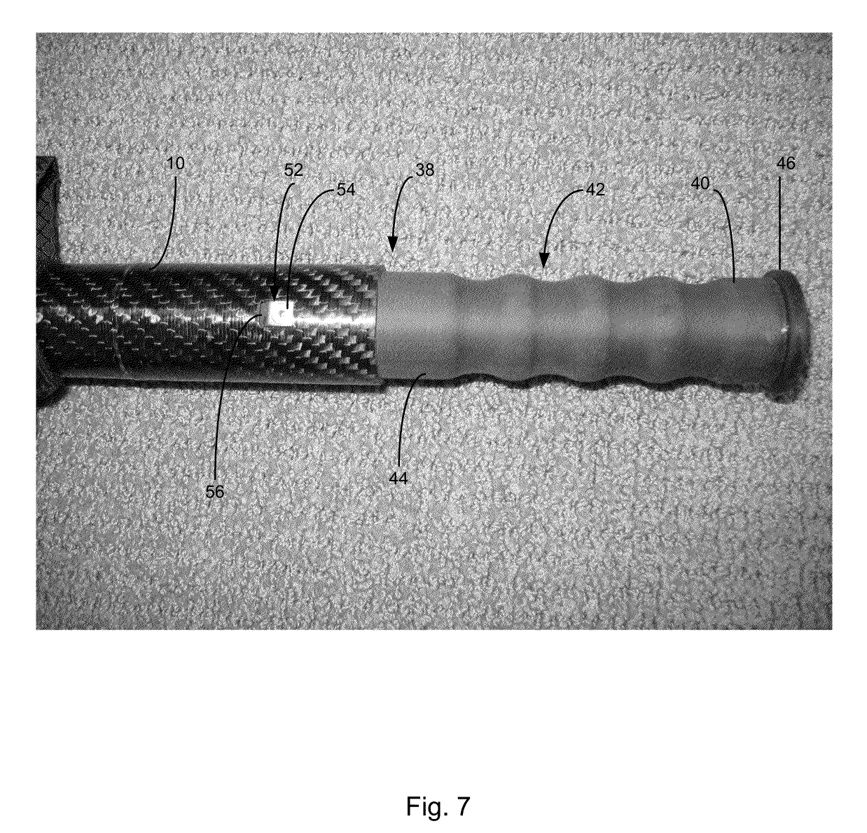

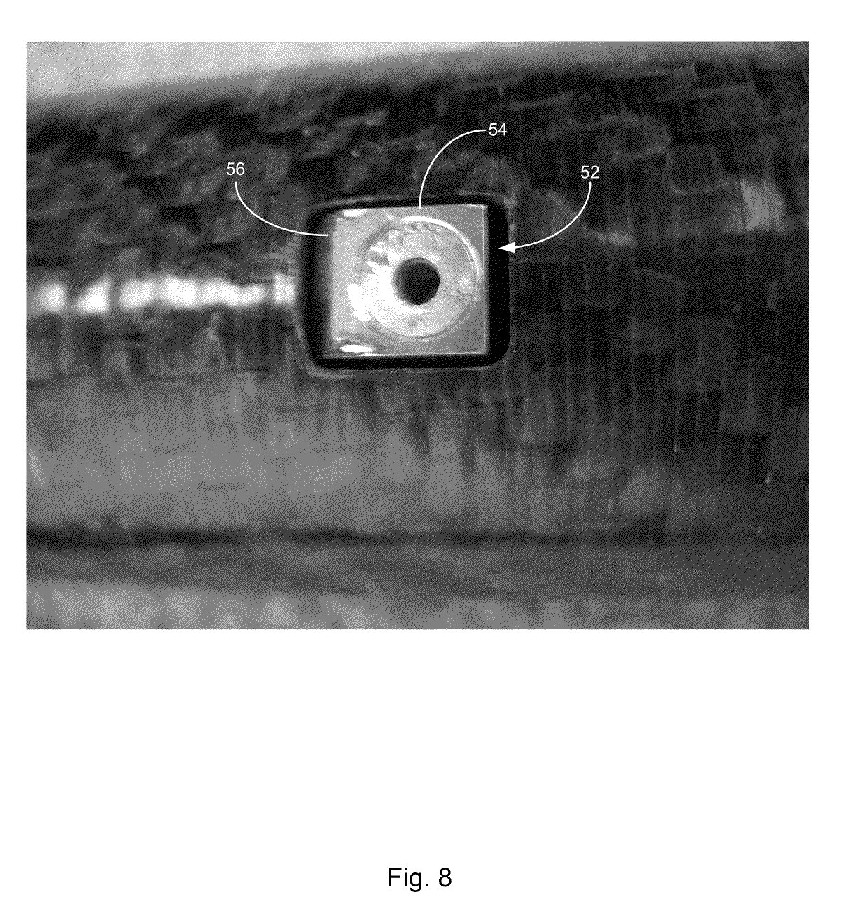

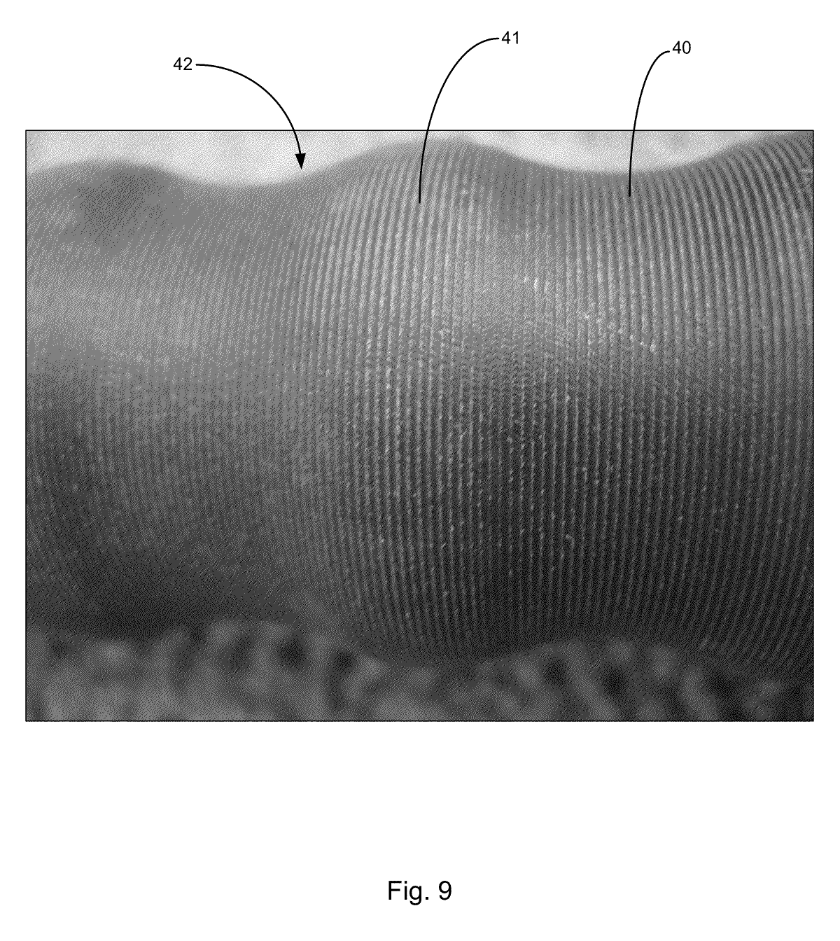

Referring to FIGS. 4-8, an extendable handle assembly, designated generally as 38, is carried at each distal end for each of frame poles 10 and 12 and operable between an extended position and a retracted position. Extendable handle assembly includes a hand grip 40 exposed when in the extended position. Referring to FIGS. 4 and 7, preferably hand grip 40 includes a plurality of grooves and ridges, designated generally as 42 to improve grip on the handle. Further, as shown in FIG. 9, hand grip 40 can include additional surface features to further improve grip, such as an arrangement of fine ridges 41 covering the surface of hand grip 40. Referring to FIGS. 4 and 7, handle assembly 38 further includes a control arm 44, which is slidably received within the distal end of the respective pole segment for controlling extraction and retraction of hand grip 40 from the end of the pole segments. Hand grip 40 is affixed to or a molded part of control arm 44. Referring to FIG. 6, when fully retracted, only lip portion 46 on hand grip 40 is disposed outside of the pole segment. When retracted, the control arm 44 and all but lip 46 of hand grip 40 are received within the hollow interior of the respective pole segment, providing a compact arrangement when in the collapsed condition for storage and transport.

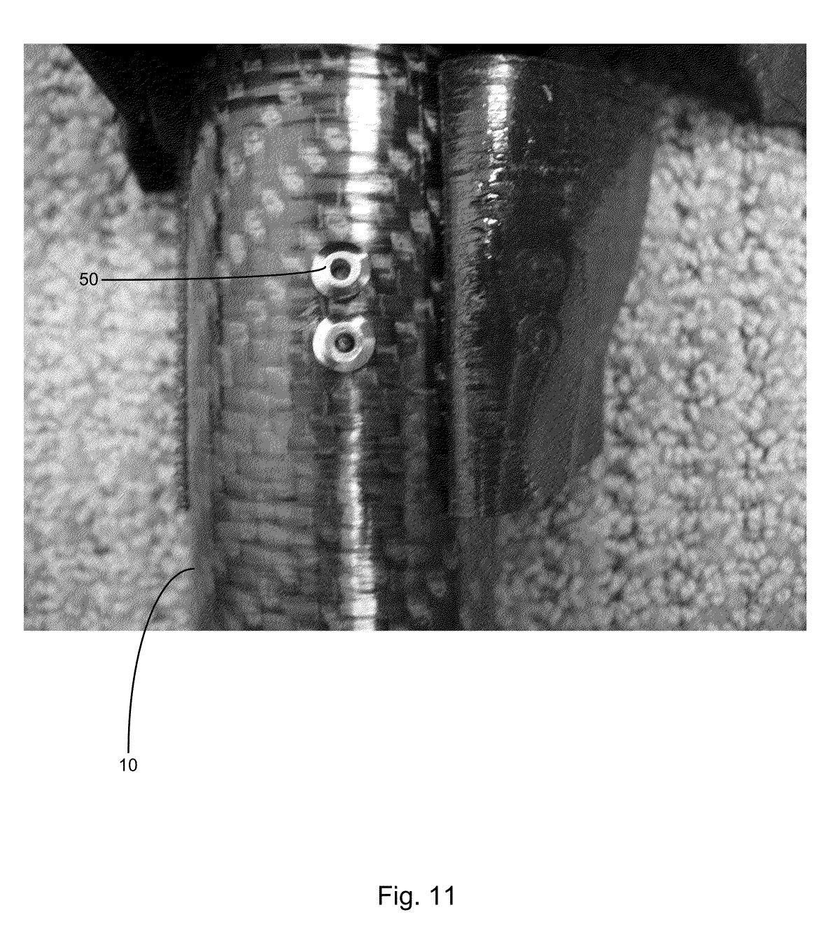

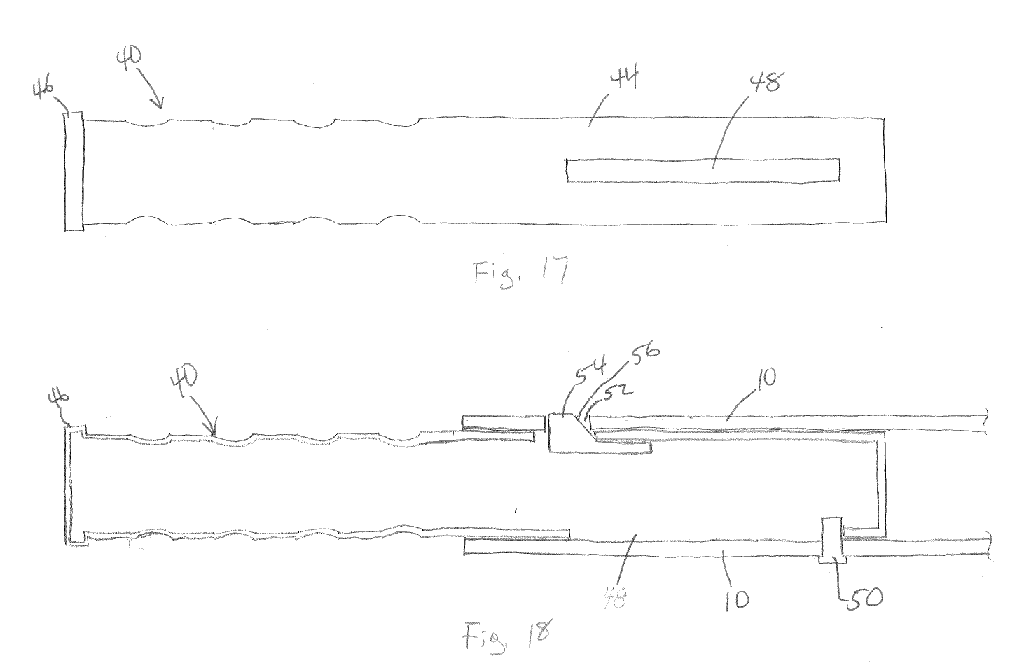

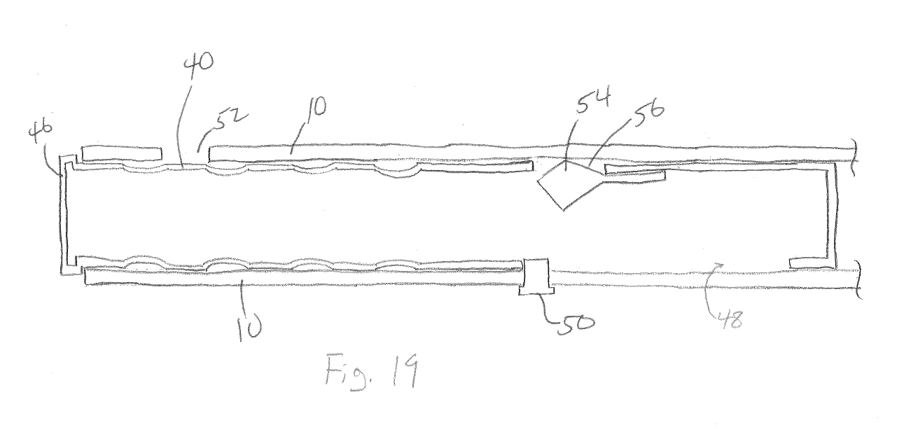

Referring to FIGS. 17-19, control arm 44 includes a control slot 48 running generally along its length. With further reference to FIG. 11, a retaining pin 50 fixedly carried by the frame pole 10 is received in control slot 48, which allows control arm 44 to extend and retract along the run of the control slot, but prevent a complete separation of the hand grip 40 and control arm 44 from the frame pole.

Referring to FIGS. 6-8 and 18-19, a keyway 52 is provided in the pole segment carrying handle assembly 38. Control arm 44 includes a spring biased key member 54 that is received into keyway 52 when hand grip 40 is moved to an extended position. In combination with retaining pin 50, the key member 54 helps prevent separation of the handle assembly from the pole segment, as well as, preventing rotation of the hand grip during use. An engaging surface 56 is provided on key member 54 having a slanted face for cooperating with the edge of keyway 52. The slanted face of engaging surface 56 allows control arm 44 to be pushed into the pole segment without depressing key member 54 to facilitate rapid retraction of the handle assembly for storage.

The stretcher discussed herein weighed approximately 3.5 kg to provide an ultra lightweight design.

While a preferred embodiment of the invention has been described using specific terms, such description is for illustrative purposes only, and it is to be understood that changes and variations may be made without departing from the spirit or scope of the following claims.

What is claimed is:

1. A collapsible lightweight stretcher for transporting injured persons, comprising:
a frame assembly having a first collapsible frame pole and a second collapsible frame pole;
said first collapsible frame pole and said second collapsible frame pole consisting of a plurality of interlocking pole segments that are releasable connectable for moving between a collapsed configuration wherein said pole segments are generally disengaged from each other, and an erected configuration wherein said pole segments are aligned and connected end to end to form each of said first and second collapsible frame poles;
an elastic retention cord disposed within a hollow interior of said first and second frame poles resisting separation of said pole segments when in said erected configuration, and maintaining said pole segments together as a bundle when in said collapsed configuration;
an extendable handle assembly slidably carried generally at a distal end of each said first and second collapsible frame poles, said handle assembly being operable between a retracted position in which a hand grip portion of said handle assembly is generally contained within said frame poles, and an extended position in which said hand grip is exposed for carrying said frame poles;
a bed member carried by said first and second collapsible frame poles adapted for receiving and supporting the weight of a person between said frame poles;
a series of support strips extending across the width of a top side of said bed member and being laterally spaced along the length of said bed member for reinforcing said bed member; and,
at least one x-brace disposed on a bottom side of said bed member defined by intersecting cross-straps arranged in an x-configuration for reinforcing said bed member.

2. The collapsible lightweight stretcher of claim 1, wherein each of said pole segments is constructed of a carbon fiber epoxy composite.

3. The collapsible lightweight stretcher of claim 1, wherein said bed member comprises a flexible fabric material selected from the group consisting of monofilament polypropylene, polyester, polyamide, nylon, and blends thereof.

4. The collapsible lightweight stretcher of claim 1, wherein said support strips are arranged generally perpendicular to said first and second collapsible frame poles.

5. The collapsible lightweight stretcher of claim 1, wherein said support strips comprise generally one inch wide nylon tape having a tensile strength of at least about 4200 lbs.

6. The collapsible lightweight stretcher of claim 1, wherein said cross-straps comprise generally two inch wide nylon tape having a tensile strength of at least about 4200 lbs.

7. The collapsible lightweight stretcher of claim 1, wherein a first x-brace is disposed on a first half of said bottom side of said bed member, and a second x-brace is disposed on a second half of said bottom side of said bed member.

8. The collapsible lightweight stretcher of claim 1, wherein said bed member includes a plurality of pole receiving loops disposed generally along opposing first and second perimeter sides of said bed member for receiving said first and second collapsible frame poles, respectively.

9. The collapsible lightweight stretcher of claim 8, wherein each of said pole receiving loops is defined by a material flap extending from said perimeter side that is folded back onto and secured to said bed member.

10. The collapsible lightweight stretcher of claim 8, including a plurality of attachment members securing said pole receiving loops to said first and second collapsible frame poles to resist shifting of said bed member on said first and second collapsible frame poles when transporting a person.

11. The collapsible lightweight stretcher of claim 10, wherein said attachment members releasably secure said bed member to said first and second collapsible frame poles.

12. The collapsible lightweight stretcher of claim 1, including a plurality of tie-down straps carried by said bed member for securing a person to said bed member.

13. The collapsible lightweight stretcher of claim 1, including at least one drainage port disposed in said bed member.

14. The collapsible lightweight stretcher of claim 1, wherein said pole segments include at least one of a male and female connector portion for interconnecting with adjacent pole segments, wherein said male connector portion is defined by a reduced diameter end portion of a pole segment, and said female connector portion is defined by said hollow interior of said pole segments at a distal end portion of a given pole segment, wherein said male connector portion is received in a releasable friction fit arrangement with an adjacent female connector portion for interconnecting said pole segments.

15. The collapsible lightweight stretcher of claim 1, wherein said extendable handle assembly includes a control arm carrying said hand grip portion, said control arm operatively associated with said frame poles for controlling extraction and retraction of said hand grip portion.

16. The collapsible lightweight stretcher of claim 15, wherein said control arm includes a control slot extending along a portion of the length of said control arm, said control slot receiving a retaining pin fixedly carried by said frame pole, wherein said control arm extends and retracts by moving said control slot along said retaining pin and is prevented from separating from said frame pole when an end of said control slot engages said retaining pin.

17. The collapsible lightweight stretcher of claim 15, wherein said control arm includes a spring biased key member being received into a keyway disposed in said frame poles, wherein said key member engages said keyway when said handle assembly is moved to said extended position to prevent separation of said handle assembly from the respective frame pole.

18. The collapsible lightweight stretcher of claim 17, wherein said spring biased key member includes a slanted engaging surface that cooperates with an edge of said keyway to directed said key member downward when said handle assembly is moved to said retracted position from said extended position.

19. A collapsible lightweight stretcher for transporting injured persons, comprising:
a frame assembly having a first collapsible frame pole and a second collapsible frame pole;
a bed member carried by said first and second collapsible frame poles adapted for receiving and supporting the weight of a person between said frame poles;
a series of support strips extending across the width of a top side of said bed member and being laterally spaced along the length of said bed member for reinforcing said bed member; and,
at least one x-brace disposed on a bottom side of said bed member defined by intersecting cross-straps arranged in an x-configuration for reinforcing said bed member.

20. A collapsible lightweight stretcher for transporting injured persons, comprising:
a frame assembly having a first collapsible frame pole and a second collapsible frame pole;
said first collapsible frame pole and said second collapsible frame pole consisting of a plurality of interlocking pole segments that are releasable connectable for moving between a collapsed configuration wherein said pole segments are generally disengaged from each other, and an erected configuration wherein said pole segments are aligned and connected end to end to form each of said first and second collapsible frame poles;
each of said pole segments being constructed of a carbon fiber epoxy composite;
an elastic retention cord disposed within a hollow interior of said first and second frame poles resisting separation of said pole segments when in said erected configuration, and maintaining said pole segments together as a bundle when in said collapsed configuration; and,
a bed member carried by said first and second collapsible frame poles adapted for receiving and supporting the weight of a person between said frame poles.
